(19) United States
(12) Patent Application Publication
(10) Pub. No.: US 2023/0411697 A1
(43) Pub. Date: Dec. 21, 2023

(54) LITHIUM SECONDARY BATTERY ELECTROLYTE FOR FORMATION OF MULTILAYER SOLID ELECTROLYTE INTERFACE LAYER, AND LITHIUM SECONDARY BATTERY INCLUDING SAME

(71) Applicants: HYUNDAI MOTOR COMPANY, Seoul (KR); KIA CORPORATION, Seoul (KR); Korea Advanced Institute of Science and Technology, Daejeon (KR)

(72) Inventors: Eun Ji Kwon, Yongin-si (KR); Won Keun Kim, Seoul (KR); Samuel Seo, Yongin-si (KR); Yeon Jong Oh, Seoul (KR); Kyu Ju Kwak, Hwaseong-si (KR); Dong Hyun Lee, Seoul (KR); Kyoung Han Ryu, Yongin-si (KR); Jun Kyu Park, Daejeon (KR); Nam Soon Choi, Daejeon (KR); Jeong A Lee, Daejeon (KR); Sae Hun Kim, Daejeon (KR)

(73) Assignees: HYUNDAI MOTORS COMPANY, Seoul (KR); KIA CORPORATION, Seoul (KR); Korea Advanced Institute of Science and Technology, Daejeon (KR)

(21) Appl. No.: 18/088,378

(22) Filed: Dec. 23, 2022

(30) Foreign Application Priority Data
Jun. 9, 2022 (KR) 10-2022-0069856

(51) Int. Cl. H01M 10/0569; H01M 10/0567; H01M 10/0568; H01M 4/04; H01M 4/40; H01M 50/46; H01M 4/62

(52) U.S. Cl. CPC H01M 10/0569; H01M 10/0567; H01M 10/0568; H01M 2004/027; H01M 4/405; H01M 50/46; H01M 4/623; H01M 4/0404

(57) ABSTRACT

An electrolyte includes a plurality of additives to form a multi-layered solid electrolyte interface layer. In addition, a lithium secondary battery including the same electrolyte is proposed.

### CROSS REFERENCE TO RELATED APPLICATION

The present application claims priority to Korean Patent Application No. 10-2022-0069856, filed Jun. 9, 2022, the entire contents of which is incorporated herein for all purposes by this reference.

### BACKGROUND OF THE PRESENT DISCLOSURE

### Field of the Present Disclosure

The present disclosure relates to an electrolyte capable of forming a solid electrolyte interface layer having a multi-layer structure by containing a plurality of additives and to a lithium secondary battery including the same electrolyte.

### Description of Related Art

To increase the energy density of a lithium secondary battery, the energy density of each of the anode and the cathode needs to be increased. Graphite used as an anode material of a lithium ion battery exhibits a performance close to the theoretical capacity. Therefore, it is difficult to further increase the energy density of a lithium ion battery. Therefore, research has been conducted on development of a next-generation anode material to produce lithium secondary batteries with high energy density.

Lithium metal has a remarkably high capacity of about 3,860 mAh/g per unit weight and an exceptionally low electrochemical potential (−3.040 V vs. standard hydrogen electrode). Therefore, it is expected to significantly increase the energy density of a battery cell when lithium metal is used as an anode material for a lithium secondary battery cell.

However, since lithium metal is highly reactive, an electrolyte easily decomposes to form a film on the lithium metal. When an uneven, ionically conductive, and mechanically weak film with deteriorated characteristics is formed, many problems such as electrolyte depletion and uneven lithium electrodeposition leading to poor stability may occur.

The development of electrolyte materials enabling stable film formation is therefore a key element in the successful development of lithium metal batteries.

The information disclosed in this Background of the present disclosure section is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a lithium secondary battery consuming less electrolyte contributing to improvement in lithium reversibility and battery lifespan.

However, the objectives of the present disclosure are not limited the ones described above. The above and other objectives of the present disclosure will become more apparent from the following description and will be realized by means recited in the claims and combinations of the means.

A lithium secondary battery electrolyte according to an exemplary embodiment of the present disclosure may include: a solution including an organic solvent, a co-solvent comprising a fluorine-based compound that is a different kind of solvent than the organic solvent, and a lithium salt; a first additive comprising a fluorine element; a second additive comprising a nitrogen element; and a third additive comprising a cyclic carbonate-based compound.

The organic solvent may include at least one selected from the group consisting of dimethyl ether, 1,2-dimethoxyethane, 1,2-diethoxyethane, 1,3-dioxolane, diethylene glycol, tetraethylene glycol, diethylene glycol dimethyl ether, triethylene glycol dimethyl ether, tetraethylene glycol dimethyl ether, and combinations thereof.

The co-solvent may include at least one selected from the group consisting of 1,1,2,2-tetrafluoroethyl-2,2,3-tetrafluoropropyl ether (TTE), 1,1,2,2-tetrafluoroethyl-1H, 1H,5H-octafluoropentyl ether (TFOFE), 1,2-(1,1,2,2-Tetrafluroethoxy) ethane (TFE), fluoroethylene carbonate (FEC), bis(2,2,2-trifluoroethyl) ether (BTFE), ethyl 4,4,4-trifluorobutyrate (ETFB), bis(2,2,2-trifluoroethyl) carbonate (TFEC), and combinations thereof.

The organic solvent and the co-solvent may be contained in a volumetric ratio of 5:5 to 9:1.

The lithium salt may include at least one selected from the group consisting of lithium bis(fluorosulfonyl) imide (LiFSI), lithium bis(trifluoromethanesulfonyl) imide (LiTFSI), LiBF₄, LiSbF₆, LiAsF₆, LiN(SO₂CF₃)₂, LiC₄F₉SO₃, LiClO₄, LiAlO₂, LiAlCl₄, LiCl, LiI, and combinations thereof.

The solution may include the lithium salt in a concentration of 1.5 M to 3M.

The first additive may include at least one selected from the group consisting of lithium difluoro (bisoxalato) phosphate (LiDFBP), lithium difluoro (bisoxalato) borate (LiDFOB), difluoroethylene carbonate (DFEC), fluoroethylene carbonate (FEC), lithium difluorophosphate (LiPO₂F₂), lithium difluoro (oxalate) borate (LiFOB), lithium tetrafluoro (oxalato) phosphate (LiTFOP), LiPF₆, and combinations thereof.

The second additive may include at least one selected from the group consisting of lithium nitrate (LiNO₃), potassium nitrate (KNO₃), sodium nitrate (NaNO₃), zinc nitrate (Zn(NO₃)₂), magnesium nitrate (Mg(NO₃)₂), lithium nitride (Li₃N), and imidazole (C₃H₄N₂).

The third additive may include a cyclic carbonate-based compound represented by Formula 1 below.

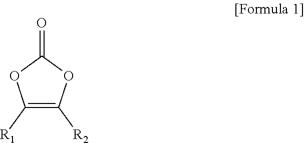

In Formula 1, R₁ and R₂ may each include a hydrogen (H) or an alkyl group having 1 to 3 carbon atoms.

The third additive may include at least one selected from the group consisting of vinylene carbonate, 4-methylvinylene carbonate, 4-ethylvinylene carbonate, and combinations thereof.

The electrolyte may include 0.01% to 1.5% by weight of the first additive, 0.1% to 5% by weight of the second additive, 0.01% to 0.5% by weight of the third additive, and the remaining percentage of the solution.

According to an exemplary embodiment of the present disclosure, a lithium secondary battery includes: a cathode including a cathode current collector and a cathode active material layer disposed on the cathode current collector; an anode including an anode current collector, a lithium metal layer disposed on the anode current collector, and a solid electrolyte interface layer disposed on the lithium metal layer; a separator disposed between the cathode and the anode; and the electrolyte impregnated in the separator.

The cathode may further include a film formed on a surface of the cathode active material layer, and the film may be derived from the first additive contained in the electrolyte.

The lithium metal layer has a thickness in the range of 10 μm to 200 μm.

The solid electrolyte interface layer may include: a first layer positioned on the lithium metal layer and including lithium fluoride (LiF); a second layer positioned on the first layer and including lithium nitride (Li₃N); a third layer positioned on the second layer and including a decomposition product of the first additive; and a fourth layer positioned on the third layer and including a polymerization product of the third additive.

The fourth layer may include polyvinylene carbonate.

The solid electrolyte interface layer may have a thickness of 100 nm to 10 μm.

The lithium secondary battery may include the electrolyte in an amount of 2 mg·mAh⁻¹ to 5 mg·mAh⁻¹ with respect to the specific capacity of electrodes.

According to an exemplary embodiment of the present disclosure, it is possible to obtain a lithium secondary battery with an increased life span due to improved lithium reversibility and minimized electrolyte consumption.

However, the advantages of the present disclosure are not limited thereto. It should be understood that the advantages of the present disclosure include all effects that can be inferred from the description given below.

### BRIEF DESCRIPTION OF THE DRAWINGS

FIG. 1 shows a cross-sectional view of a lithium secondary battery according to an exemplary embodiment of the present disclosure;

FIG. 2 shows a lithium metal layer and a solid electrolyte interface layer according to an exemplary embodiment of the present disclosure;

FIG. 3A shows the cycle discharging capacity of each of the lithium secondary batteries according to Example 1 and Comparative Examples 1 to 4;

FIG. 3B shows the Coulomb efficiency of each of the lithium secondary batteries according to Example 1 and Comparative Examples 1 to 4;

FIG. 4A shows F1s XPS results for the cathodes of Example 1 and Comparative Examples 1 to 4;

FIG. 4B shows S2p XPS results for the cathodes of Example 1 and Comparative Examples 1 to 4;

FIG. 4C shows P2p XPS results for the cathodes of Example 1 and Comparative Examples 1 to 4;

FIG. 4D shows O1s XPS results for the cathodes of Example 1 and Comparative Examples 1 to 4;

FIG. 4E shows C1s XPS results for the cathodes of Example 1 and Comparative Examples 1 to 4;

FIG. 5A shows F1s XPS results for the anodes of Example 1 and Comparative Examples 1 to 4;

FIG. 5B shows S2p XPS results for the anodes of Example 1 and Comparative Examples 1 to 4;

FIG. 5C shows P2p XPS results for the anodes of Example 1 and Comparative Examples 1 to 4;

FIG. 5D shows O1s XPS results for the anodes of Example 1 and Comparative Examples 1 to 4;

FIG. 5E shows C1s XPS results for the anodes of Example 1 and Comparative Examples 1 to 4; and

FIG. 6 shows the results of measurement of the initial efficiency of each of the lithium secondary batteries according to Example 2 and Comparative Examples 5 to 8.

It may be understood that the appended drawings are not necessarily to scale, presenting a somewhat simplified representation of various features illustrative of the basic principles of the present disclosure. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present disclosure(s) will be described in conjunction with exemplary embodiments, it will be understood that the present description is not intended to limit the present disclosure(s) to those exemplary embodiments. On the contrary, the present disclosure(s) is/are intended to cover not only the exemplary embodiments, but also various alternatives, modifications, equivalents and other embodiments, which may be included within the spirit and scope of the present disclosure as defined by the appended claims.

Above objectives, other objectives, features, and advantages of the present disclosure will be readily understood from the following exemplary embodiments associated with the accompanying drawings. However, the present disclosure is not limited to the embodiments described herein and may be embodied in other forms. The embodiments described herein are provided so that the present disclosure can be made thorough and complete and that the spirit of the present disclosure can be fully conveyed to those skilled in the art.

Throughout the drawings, like elements are denoted by like reference numerals. In the accompanying drawings, the dimensions of the structures are larger than actual sizes for clarity of the present disclosure. Terms used in the specification, “first”, “second”, etc., may be used to describe various components, but the components are not to be construed as being limited to the terms. These terms are used only for the purpose of distinguishing a component from another component. For example, without departing from the scope of the present disclosure, a first component may be referred as a second component, and a second component may be also referred to as a first component. As used herein, the singular forms “a”, “an”, and “the” are intended to include the plural forms as well unless the context clearly indicates otherwise.

It will be further understood that the terms “comprises”, “includes”, or “has” when used in the present specification specify the presence of stated features, regions, integers, steps, operations, elements and/or components, but do not preclude the presence or addition of one or more other features, regions, integers, steps, operations, elements, components and/or combinations thereof. It will also be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in the present specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

Lithium metal is highly reactive. For this reason and thus decomposes an electrolyte upon contact with the electrolyte. As a result, a solid electrolyte interface layer is formed on the surface of lithium metal. In this case, when the solid electrolyte surface layer is non-uniformly formed, the supply of lithium ions is unstable, resulting in the growth of lithium dendrites on the surface of the lithium metal.

In addition, uneven electrodeposition of lithium ions causes a continuous side reaction between the lithium metal and the electrolyte, resulting in thickening of the solid electrolyte surface layer and depletion of the electrolyte.

The present disclosure aims to form a stable solid electrolyte interface layer on the surface of a lithium metal to minimize side reactions between an electrolyte and the lithium metal and consumption of the electrolyte.

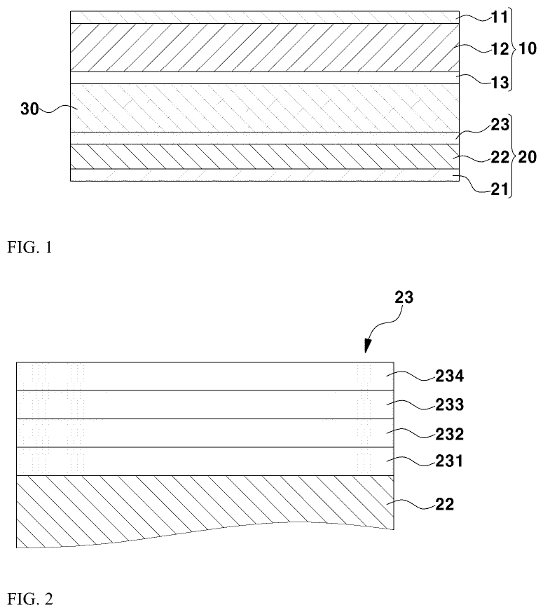

FIG. 1 is a cross-sectional view illustrating a lithium secondary battery according to an exemplary embodiment of the present disclosure. Referring to FIG. 1, the lithium secondary battery may include a cathode 10, an anode 20, a separator 30 disposed between the cathode 10 and the anode 20, and an electrolyte (not illustrated) with which the separator 30 is impregnated.

The cathode 10 includes a cathode current collector 11 and a cathode active material layer 12 positioned on the cathode current collector 11.

The cathode current collector 11 may be an electrically conductive plate-shaped substrate. The cathode current collector 11 may include an aluminum foil.

The cathode active material layer 12 may include a cathode active material, a binder, and a conductive material.

The cathode active material may include at least one selected from the group consisting of LiCo₂, LiNiCoMnO₂, LiNiCoAlO₂, LiMn₂O₄, LiFeO₄, and combinations thereof. However, examples of the cathode active material are not limited thereto, and any type of cathode active material that is commonly used in the art to which the present disclosure belongs can be used.

The binder is a component that binds particles of the cathode active material to each other. Examples of the binder include polyvinyl alcohol, carboxymethyl cellulose, hydroxypropyl cellulose, diacetyl cellulose, polyvinyl chloride, carboxylated polyvinyl chloride, polyvinyl fluoride, polymer including ethylene oxide, polyvinylpyrrolidone, poly urethane, polytetrafluoroethylene, polyvinylidene fluoride, polyethylene, polypropylene, styrene-butadiene rubber, acrylated styrene-butadiene rubber, epoxy resin, nylon, etc. but are not limited thereto.

The conductive material is a component that impart a conductivity to the cathode active material layer 12. The conductive material may include any material capable of conducting electrons without causing chemical changes in the cathode active material layer 12. For example, examples of the conductive material include natural graphite, synthetic graphite, carbon black, carbon fibers, copper, nickel, aluminum, silver, etc.

The anode 20 may include an anode current collector 21, a lithium metal layer 22 positioned on the anode current collector 21, and a solid electrolyte interface layer 23 positioned on the lithium metal layer 22.

The anode current collector 21 may be an electrically conductive plate-shaped substrate. Specifically, the anode current collector 21 may include at least one material selected from the group consisting of nickel (Ni), stainless steel (SUS), and combinations thereof.

The lithium metal layer 22 may include lithium metal or lithium alloy.

The lithium metal alloy may include an alloy of lithium and at least one metal selected from the group consisting of Na, K, Rb, Cs, Fr, Be, Mg, Ca, Sr, Si, Sb, Pb, In, Zn, Ba, Ra, Ge, Al, Sn, and combinations thereof.

In order to increase the energy density of a lithium secondary battery, the thickness of the lithium metal layer 22 needs to be reduced. The thickness of the lithium metal layer 22 may be in the range of 10 μm to 200 μm, 10 μm to 130 μm, or 10 nm to 100 μm. When the thickness of the lithium metal layer 22 exceeds 200 μm, the effect of increasing the energy density of the lithium secondary battery may be reduced, and the reversibility of lithium plating/stripping may be deteriorated.

On the other hand, when the thickness of the lithium metal layer 22 is reduced, the amount of available lithium metal is reduced compared to the case where the lithium metal layer 22 is thick. Therefore, the coefficient of utilization of lithium metal needs to be increased. The coefficient of utilization of lithium metal can be increased by improving the reversibility of lithium ions. It is an objective of the present disclosure to increase the utilization of lithium metal to about 75% or more.

In addition, the energy density of a lithium secondary battery can be increased by reducing the amount of an electrolyte. In order to reduce the amount of the electrolyte while using the thin lithium metal layer 22 as described above, it is necessary to minimize side reactions between lithium metal and electrolyte and to improve the reversibility of lithium ions. To this end, the present disclosure features that the anode 20 is provided with the solid electrolyte interface layer 23 having a multi-layer structure as illustrated in FIG. 2, and an electrolyte containing a specific additive is used to form the solid electrolyte surface layer 23.

The electrolyte according to an exemplary embodiment of the present disclosure may include: a solution including an organic solvent, a co-solvent that is a different kind of solvent than the organic solvent and contains a fluorine-based compound, and a lithium salt; a first additive including a fluorine element; a second additive including a nitrogen element; and a third additive including a cyclic carbonate-based compound.

The organic solvent may include at least one selected from the group consisting of dimethyl ether, 1,2-dimethoxyethane, 1,2-diethoxyethane, 1,3-dioxolane, diethylene glycol, tetraethylene glycol, diethylene glycol dimethyl ether, triethylene glycol dimethyl ether, tetraethylene glycol dimethyl ether, and combinations thereof. Specifically, it is preferable to use 1,2-dimethoxyethane, which has a high dissociation capacity for the lithium salt and a low reactivity with respect to the lithium metal, as the organic solvent.

The co-solvent is a solvent different from the organic solvent and may contain a fluorine-based compound.

The co-solvent may have a smaller highest occupied molecular orbital (HOMO) value than the organic solvent. Specifically, the co-solvent may have a HOMO value not lower than −11 eV and not higher than −7.5 eV (i.e., −11 eV and ≤HOMO≤−7.5 eV). Since the co-solvent has a lower HOMO value than the organic solvent, the stability of the lithium secondary battery at high voltage is improved.

The co-solvent may include at least one selected from the group consisting of 1,1,2,2-tetrafluoroethyl-2,2,3-tetrafluoropropyl ether (TTE), 1,1,2,2-tetrafluoroethyl-1H,1H,5H-octafluoropentyl ether (TFOFE), 1,2-(1,1,2,2-Tetrafluroethoxy) ethane (TFE), fluoroethylene carbonate (FEC), bis(2,2,2-trifluoroethyl) ether (BTFE), ethyl 4,4,4-trifluorobutyrate (ETFB), bis(2,2,2-trifluoroethyl) carbonate (TFEC), and combinations thereof.

When the organic solvent and the co-solvent are used in combination, the content of free solvent that does not solvate lithium ions in the organic solvent decreases, and the oxidation stability of the electrolyte significantly increases. In addition, when the lithium secondary battery undergoes aging, side reactions between the free-solvent and the lithium metal side reactions are reduced, so that the capacity and the charging efficiency of the lithium secondary battery are not reduced.

In the electrolyte, the organic solvent and the co-solvent may be contained in a volume ratio in the range of 5:5 to 9:1. When the volume ratio is lower than the range, since the content of the co-solvent is reduced, the first layer 231 including lithium fluoride (LiF) is not sufficiently formed on the surface of the lithium metal layer 22. This will be described later. On the other hand, when the volume ratio exceeds the range, the first layer 231 is excessively formed. Therefore, the electrodeposition overvoltage is increased, and the life span of the cell is reduced.

The lithium salt may include at least one selected from the group consisting of lithium bis(fluorosulfonyl) imide (LiFSI), lithium bis(trifluoromethanesulfonyl) imide (LiTFSI), LiBF₄, LiSbF₆, LiAsF₆, LiN(SO₂CF₃)₂, LiC₄F₉SO₃, LiClO₄, LiAlO₂, LiAlCl₄, LiCl, LiI, and combinations thereof.

The solution may include the lithium salt in a concentration of 1.5 M to 3M. When the concentration of the lithium salt is lower than the range described above, the reversibility of lithium ions decreases and a free solvent that does not solvate lithium ions is generated. Therefore, the surface of the lithium metal layer 22 can undergo side reactions. Since the decomposition products produced by the side reactions continuously accumulate, the utilization of lithium may be reduced. On the other hand, when the concentration of the lithium salt exceeds the range, the viscosity of the electrolyte is increased. In this case, the resistance of the battery increases and the output voltage drops.

The additives are used to form the solid electrolyte interface layer 23 having a multi-layer structure as illustrated in FIG. 2.

The first additive may include at least one selected from the group consisting of lithium difluoro (bisoxalato) phosphate (LiDFBP), lithium difluoro (bisoxalato) borate (LiDFOB), difluoroethylene carbonate (DFEC), fluoroethylene carbonate (FEC), lithium difluorophosphate (LiPO₂F₂), lithium difluoro (oxalate) borate (LiFOB), lithium tetrafluoro (oxalato) phosphate (LiTFOP), LiPF₆, and combinations thereof.

The second additive may include at least one selected from the group consisting of lithium nitrate (LiNO₃), potassium nitrate (KNO₃), sodium nitrate (NaNO₃), zinc nitrate (Zn(NO₃)₂), magnesium nitrate (Mg(NO₃)₂), lithium nitride (Li₃N), and imidazole (C₃H₄N₂).

The third additive may include a cyclic carbonate-based compound represented by Formula 1 below.

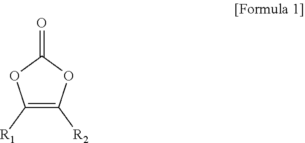

In Formula 1, R₁ and R₂ may each include a hydrogen (H) or an alkyl group having 1 to 3 carbon atoms.

Specifically, the third additive may include at least one selected from the group consisting of vinylene carbonate, 4-methylvinylene carbonate, 4-ethylvinylene carbonate, and combinations thereof.

After manufacturing the lithium secondary battery using an electrolyte including the co-solvent, a formation process of charging and discharging the lithium secondary battery is performed. After completing the formation process, the solid electrolyte interface layer 23 having a multi-layer structure as illustrated in FIG. 2 is formed on the lithium metal layer 22.

Referring to FIG. 2, the solid electrolyte interface layer 23 may include: a first layer 231 positioned on the lithium metal layer 22 and containing lithium fluoride (LiF); a second layer 232 positioned on the first layer 231 and containing lithium nitride (Li₃N); a third layer 233 positioned on the second layer 232 and containing a decomposition product of the first additive; and a fourth layer 234 positioned on the third layer 233 and containing a polymerization product of the third additive.

When the lithium secondary battery to which the electrolyte is applied undergoes an aging process for a period of time and a pre-cycle charging and discharging process for formation of the lithium secondary battery, the multi-layer solid electrolyte interface layer 23 can be formed because the voltage levels at which the decomposition, reaction, and polymerization of the first additive, the second additive, and the third additive occur to change the chemical structure are different.

Specifically, when the lithium secondary battery is aged, the co-solvent decomposes and the product of the decomposition reacts with lithium ions to form the first layer 231 containing lithium fluoride (LiF).

Next, when the voltage level for charging the lithium secondary battery is about 3.7 V, the second additive decomposes to form the second layer 232 containing lithium nitride (Li₃N).

When the voltage level of the lithium secondary battery becomes about 4 V, the first additive decomposes to form the third layer 233 containing a compound having a P—O bond.

Then, when the charging is completed, the third additive 233 is polymerized to form the fourth layer 234 containing a polymer produced through the polymerization.

The above-mentioned voltage conditions illustrate the time point of decomposition of each of the additives used in preparation examples described below and are not limited to the particular values.

The first layer 231 has a high strength. Therefore, it is possible to suppress the growth of lithium dendrites and the excessive volume expansion on the surface of the lithium metal layer 22.

The second layer 232 and the third layer 233 have excellent lithium ion conductivity. Therefore, it is possible to lower the resistance of the battery and to induce uniform lithium plating and stripping.

The third layer 234 is flexible and has a high strength because it contains the polymerization product. Therefore, the third layer 234 does not break or crack even under conditions of repeated volumetric expansion or contraction of the lithium metal layer 22, caused by plating and stripping of lithium.

In order to properly form each layer of the multi-layered solid electrolyte surface layer 23, the content of each of the first, second, and third additives in the electrolyte needs to be adjusted to be in an adequate range. The electrolyte may include 0.01% to 1.5% by weight of the first additive, 0.1% to 5% by weight of the second additive, 0.01% to 0.5% by weight of the third additive, and the remaining percentage of the solution. In particular, when the content of the third additive exceeds 0.5% by weight, a portion of the third additive which does not form the third layer 234 is reductively decomposed, and the decomposition product reacts with lithium to produce lithium carbonate (Li₂CO₃). Lithium carbonate (Li₂CO₃) has a narrow energy band gap leading to a high electron conductivity. Therefore, lithium carbonate may cause a side reaction between the electrolyte and the lithium metal layer 22.

When the content of the third additive exceeds 0.5% by weight, the lithium salt decomposes and the decomposition product reacts with the reductive decomposition product of the third additive to form a film containing lithium carbonate (Li₂CO₃) on the cathode active material layer 12. In addition, even though the lithium salt does not decompose, an excessive amount of the third additive causes the decomposition of the co-solvent to form a high-resistance film containing lithium oxide (Li₂O) on the cathode active material layer 12.

When the content of the third additive is in the range of 0.01% to 0.5% by weight, a film 13 containing a compound derived from the first additive may be formed on the cathode active material layer 12.

The film 13 may contain a compound having a P—O bond. Since the compound having a P—O bond highly conducts lithium ions, it is possible to prevent the cathode active material layer 12 from deteriorating. In addition, it is possible to prevent contact between the cathode active material layer 12 and the electrolyte, thereby preventing inaction between the cathode active material layer 12 and the electrolyte.

The thickness of the lithium metal layer 23 may be in the range of 10 μm to 10 μm, 10 μm to 3 μm, or 10 nm to 2 μm. When the thickness of the solid electrolyte interface layer 23 is smaller than 100 nm, it is difficult to suppress the growth of lithium dendrites on the lithium metal layer 22. When the thickness of the solid electrolyte interface layer 23 is larger than 10 μm, the migration of lithium ions is prevented.

The electrolyte 30 may be contained in the separator 30 (not illustrated).

The separator 30 may be a film with a single-layer film made of any one selected from polyethylene, polypropylene, polyvinylidene fluoride or a multi-layer film made of two or more materials selected from polyethylene, polypropylene, polyvinylidene fluoride. The separator 30 may be a hybrid multi-layer separator such as a two-layer separator of polyethylene/polypropylene or a three-layer separator of polyethylene/polypropylene/polyethylene or polypropylene/polyethylene/polypropylene.

In the lithium secondary battery, the electrolyte may be contained in an amount of 2 mg·mAh⁻¹ to 5 mg·mAh⁻¹ with respect to the specific capacity of electrodes. The amount of the electrolyte is the weight of the electrolyte divided by the capacity of the electrodes. When the sum of the weights of the respective components measured before assembling the lithium secondary battery is set as A, and the sum of the weights measured after assembling the lithium secondary battery and injecting the electrolyte is set as B, the weight of the electrolyte is calculated as B−A. By dividing the weight of the electrolyte by the discharging capacity of the lithium secondary battery, measured after the formation process, the amount of the electrolyte is obtained.

Hereinafter, the present disclosure will be described in more detail with reference to examples and comparative examples. However, the examples described below are provided only to aid understanding of the present disclosure and thus should not be construed as limiting to the scope of the present disclosure.

### Preparation Examples and Comparative Preparation Examples 1 to 4: Preparation of Electrolyte

1,2-dimethoxyethane as an organic solvent was mixed with 1,1,2,2-tetrafluoroethyl-1H,1H,5H-octafluoropentyl ether (TFOFE) as a co-solvent were mixed in a volume ratio of 8:2. A solution was prepared by adding lithium bis(fluorosulfonyl)imide (LiFSI) as a lithium salt to the extent that the concentration of the lithium salt becomes 2.5 M. An electrolyte was prepared by adding lithium difluorophosphate (LiPO₂F₂) as a first additive, lithium nitrate (LiNO₃) as a second additive, and vinylene carbonate as a third additive to the solution. The contents of the first, second, and third additives added are shown in Table 1.

TABLE 1

| | | | | | Content |
|---|---|---|---|---|---|
| | Volumetric | | Content | Content | of third |
| | ratio of | | of first | of second | additive |
| | organic | | additive | additive | [wt %] |
| | solvent to | Concentration | [wt %] | [wt %] | Vinylene |
| Classification | co-solvent | of lithium salt | LiPO₂F₂ | LiNO₃ | carbonate |
| [Preparation | 8:2 | 2.5M | 0.3 | 1 | 0.5 |
| Example] | | | | | |
| Comparative | 8:2 | 2.5M | 0.3 | 1 | 2 |
| Preparation | | | | | |
| Example 1 | | | | | |
| Comparative | 8:2 | 2.5M | 0.3 | 1 | 1.5 |
| Preparation | | | | | |
| Example 2 | | | | | |
| Comparative | 8:2 | 2.5M | 0.3 | 1 | 1.0 |
| Preparation | | | | | |
| Example 3 | | | | | |
| Comparative | 8:2 | 2.5M | 0.3 | 1 | 0 |
| Preparation | | | | | |
| Example 4 | | | | | |

The content of each additive is a value based on the total weight of the electrolyte.

### Example 1 and Comparative Examples 1 to 4

A lithium metal layer having a thickness of about 20 μm was prepared. A cathode active material layer containing LiNiCoMnO₂ (NCM811:NCM622=9:1, weight ratio) was prepared. A separator having a thickness of about 1.3 mm was inserted between an anode and a cathode obtain a laminate. The laminates were charged with about 15 μL of one of the electrolytes of Example 1 and Comparative Examples 1 to 4. Thus, lithium secondary batteries of Example 1 and Comparative Examples 1 and 4 were obtained.

The life span of each of the lithium secondary batteries according to Example 1 and Comparative Examples 1 to 4 was evaluated according to the conditions shown below.

Test conditions: aging at room temperature for 10 hours, formation charging/discharging 2 times (0.1 C, 4.2 V/−0.1 C, 3.0 V), cycles (1 C, 4.2 V/CV: 4.2 V, 0.05 C/−1 C, 3.0 V/rest 30 minutes), 1 C=182.9 mAh·g⁻¹

Coulomb Efficiency (%):(Cycle Discharging Capacity/Cycle Charging Capacity)×100

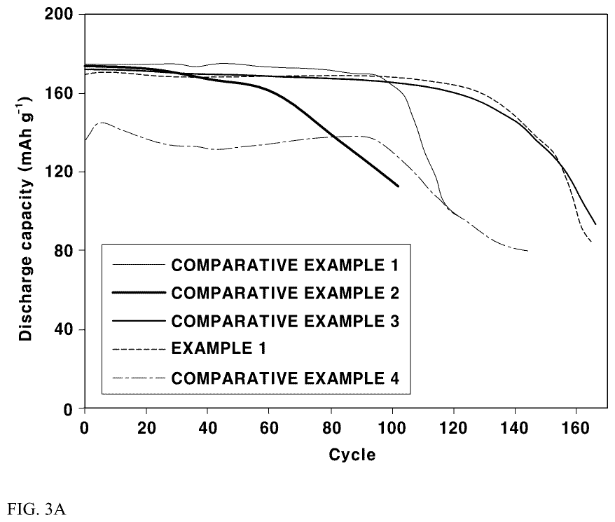

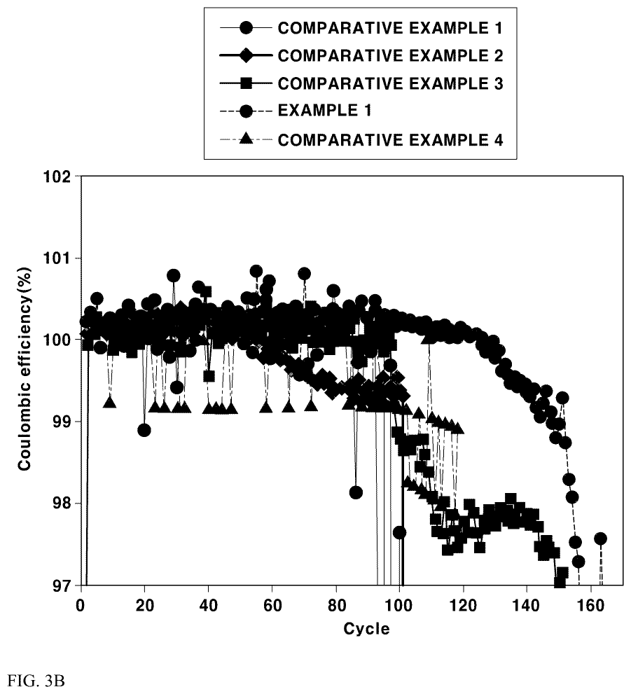

FIG. 3A is a graph showing the cycle discharging capacity of each of the lithium secondary batteries according to Example 1 and Comparative Examples 1 to 4. FIG. 3B is a Coulomb efficiency graph of the lithium secondary batteries according to Example 1 and Comparative Examples 1 to 4.

Referring to FIG. 3A, in the case of Comparative Examples 1 and 2 in which the content of the third additive was 2.0% by weight and 1.5% by weight, respectively, and a solid electrolyte interface layer (i.e., fourth layer) containing lithium carbonate (Li₂CO₃) was formed by an excess of vinylene carbonate (i.e., the fourth layer). Therefore, a side reaction between the lithium metal layer and the electrolyte occurred and the lifespan was reduced accordingly.

Referring to FIG. 3B, in the case of Comparative Example 3 in which the content of the third additive is 1.0% by weight, the Coulomb efficiency was unstable after 100 cycles.

On the other hand, in the case of Example 1 in which the content of the third additive was 0.5% by weight, referring to FIG. 3A, the battery had a long lifespan such that 156 times of charging and discharging could be performed at a capacity retention rate of 70%, and the battery exhibited a high average Coulomb efficiency of about 99.95% during the cycles.

From these results, it is seen that the lithium secondary battery according to an exemplary embodiment of the present disclosure has an excellent lifespan performance under evaluation conditions of a lithium metal layer having a high specific capacity of 3.0 mAh·cm⁻², a thickness of 20 μm, and a lithium utilization rate of about 75%, a high current density of 3.0 mA·cm⁻², and a low electrolyte amount of 3.6 mg·mAh⁻¹.

After the charging and discharging for the above-described evaluation was completed, the lithium secondary batteries of Example 1 and Comparative Examples 1 and 4 were dismantled, and the anode and cathode of each battery were analyzed by X-ray photoelectron spectroscopy (XPS).

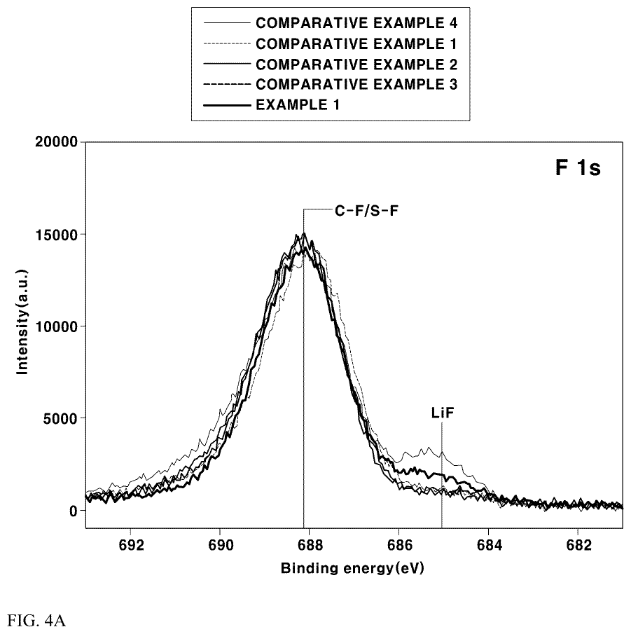

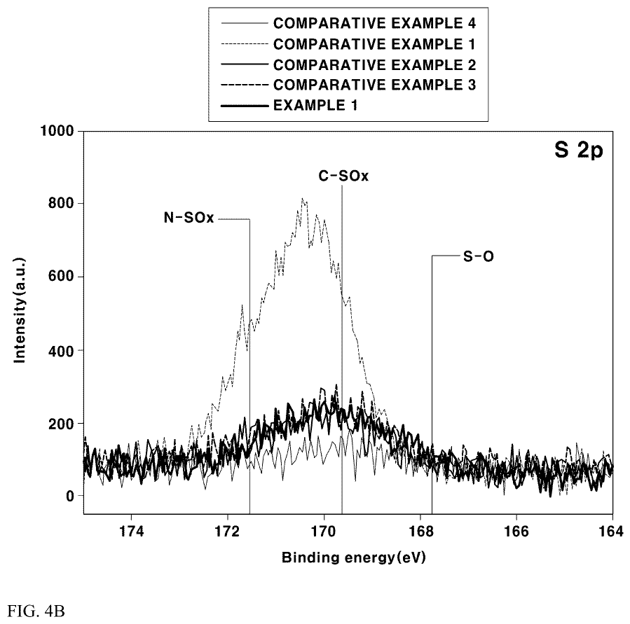

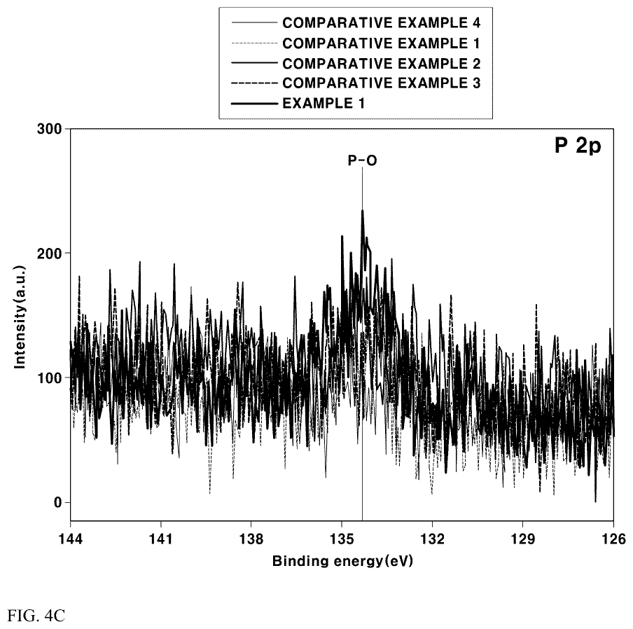

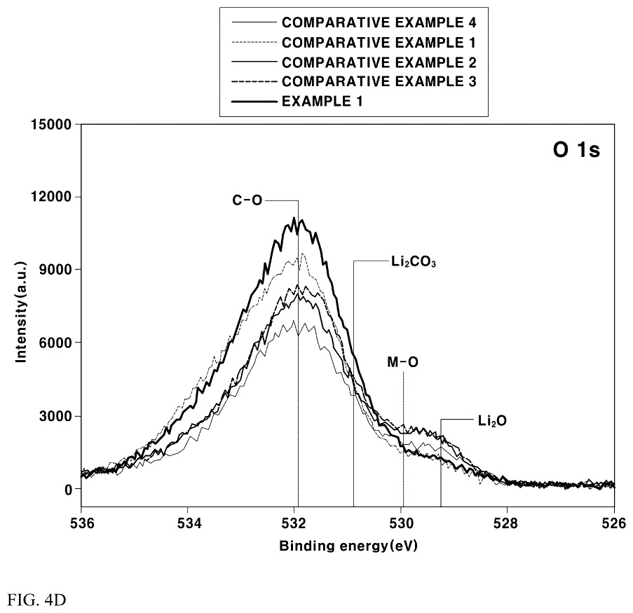

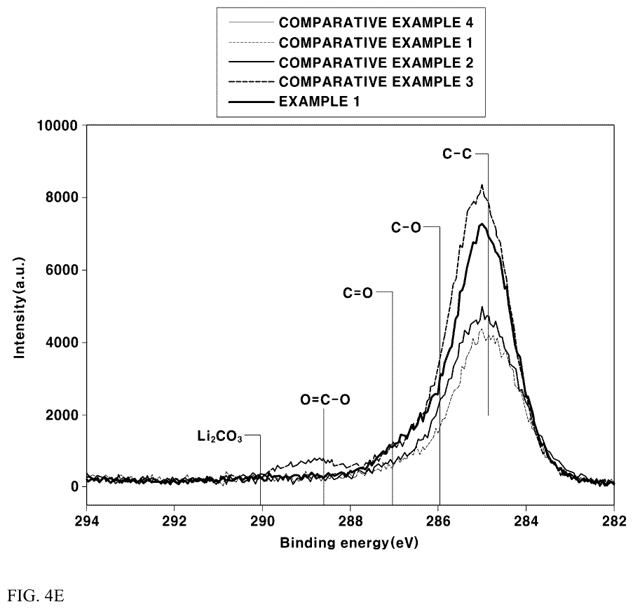

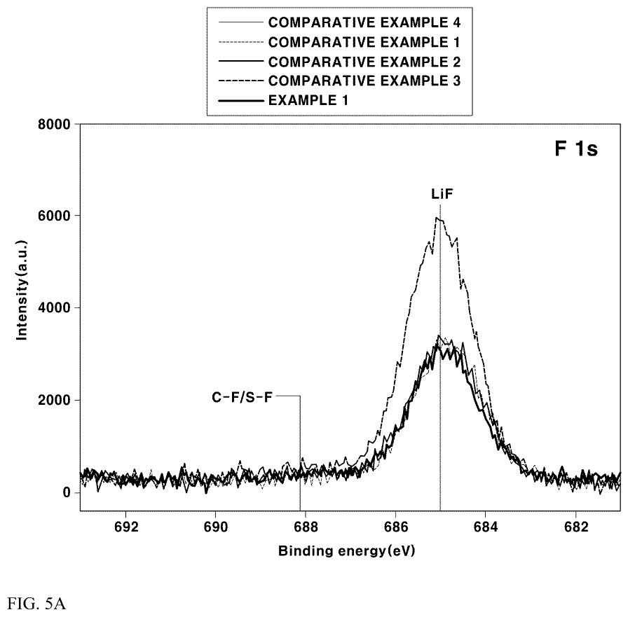

FIG. 4A shows F1s XPS results for the cathodes of Example 1 and Comparative Examples 1 to 4. FIG. 4B shows S2p XPS results for the cathodes of Example 1 and Comparative Examples 1 to 4. FIG. 4C shows P2p XPS results for the cathodes of Example 1 and Comparative Examples 1 to 4. FIG. 4D shows O1s XPS results for the cathodes of Example 1 and Comparative Examples 1 to 4. FIG. 4E shows C1s XPS results for the cathodes of Example 1 and Comparative Examples 1 to 4.

Referring to FIG. 4B showing S2p XPS results and FIG. 4D showing O1s XPS results, in the case of Comparative Example 1 in which the content of the third additive was 2.0% by weight, the film formed by the decomposition of the lithium salt on the cathode active material layer was relatively thick. In the cases of Comparative Examples 2 and 3 in which the content of the third additive was lower than that as in Comparative Example 1, the film formation caused by the decomposition of the lithium salt was suppressed compared to the case of Comparative Example 1, but a high-resistance film based on lithium oxide (Li₂O) formed by the decomposition of the third additive and the co-solvent was formed.

Referring to FIGS. 4A to 4E, Example 1 showed that the decomposition of the lithium salt was effectively inhibited, and a compound having a polar P—O bond originating in the first additive, LiPO₂F₂, formed a film. Since the film highly conducts lithium ions, it is possible to prevent deterioration of the cathode active material layer and a side reaction between the cathode active material layer and the electrolyte.

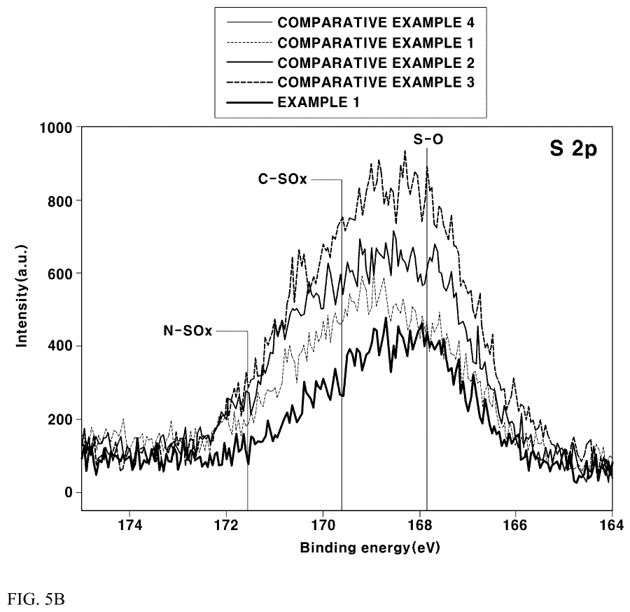

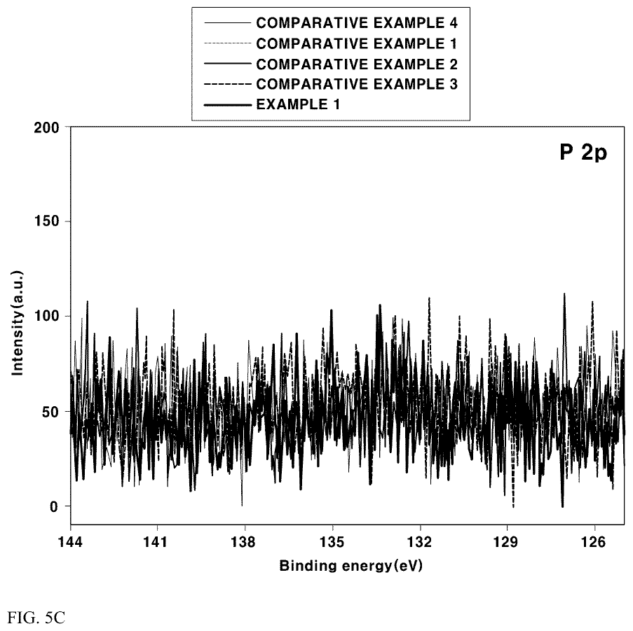

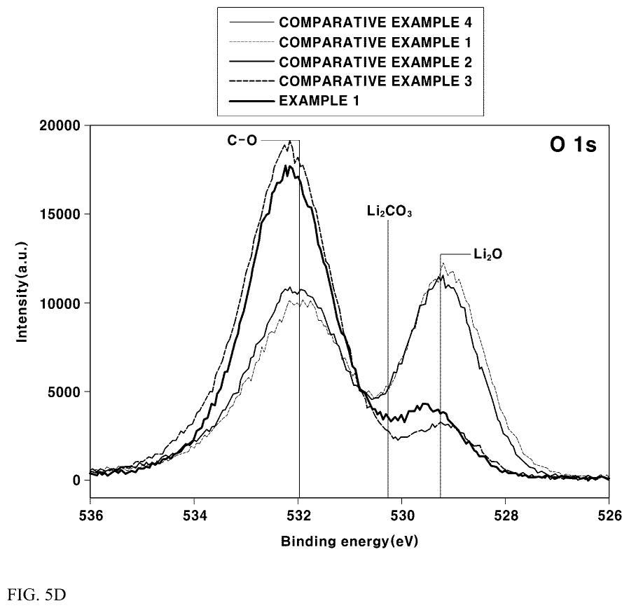

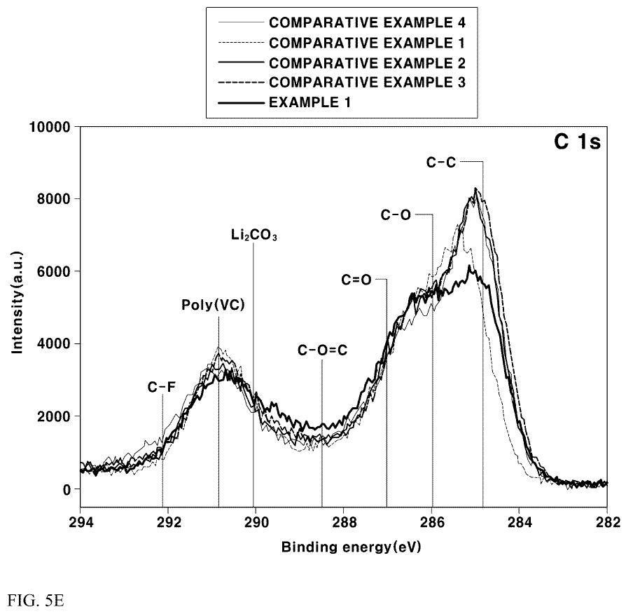

FIG. 5A shows F1s XPS results for the anodes of Example 1 and Comparative Examples 1 to 4. FIG. 5B shows S2p XPS results for the anodes of Example 1 and Comparative Examples 1 to 4. FIG. 5C shows P2p XPS results for the anodes of Example 1 and Comparative Examples 1 to 4. FIG. 5D shows O1s XPS results for the anodes of Example 1 and Comparative Examples 1 to 4. FIG. 5E shows C1s XPS results for the anodes of Example 1 and Comparative Examples 1 to 4.

Referring to the C1s XPS results of FIG. 5E, Example 1 and Comparative Examples 1 to 4 in which the third additive was added showed a phenomenon that a fourth layer containing a polymerization product (poly(VC)) of the third additive was formed. However, referring to the O1s results of FIG. 5D, Comparative Examples 1 and 2 in which the addition of the third additive was excessive showed a phenomenon that lithium carbonate (Li₂CO₃) and lithium oxide (Li₂O) generated by the decomposition of the co-solvent were present in the solid electrolyte interface layer. Since lithium carbonate (Li₂CO₃) has a narrow energy band gap, the solid electrolyte interface layer containing lithium carbonate (Li₂CO₃) facilitates the migration of electrons, resulting in the side reaction between the electrolyte and the lithium metal layer. This is consistent with the lifespan deterioration phenomenon of Comparative Examples 1 and 2, shown in FIG. 3A and FIG. 3B.

Referring to the F1s XPS results of FIG. 5A and the S2p XPS results of FIG. 5B, Comparative Example 3 in which the content of the third additive was 1.0% by weight showed a phenomenon in which a thick solid electrolyte interface layer based on lithium fluoride (LiF) and sulfur (Sulfur), caused by the decomposition of a lithium salt, was formed.

Referring to the O1s XPS results of the of FIG. 5D, Example 1 in which the content of the third additive is 0.5% by weight showed a phenomenon in which a solid electrolyte interface layer did not contain lithium carbonate (Li₂CO₃) because the third additive is entirely consumed to form a fourth layer containing polyvinylene carbonate. Referring to the F1s XPS results of FIG. 5A and the S2p XPS results of FIG. 5B, in Example 1, a high-strength first layer containing lithium fluoride (LiF) was formed to a suitable thickness, thereby having effectively inhibited the growth of lithium dendrites on a lithium metal layer. These results are consistent with the results of FIG. 3A and FIG. 3B in which the lifespan of the battery of Example 1 is 156 cycles long at a capacity retention rate of 70%.

### Example 2 and Comparative Examples 5 to 8

In each case, a lithium metal layer having a thickness of about 20 μm was prepared. After laminating a separator on a cathode, a copper foil having a thickness of about 20 μm was attached to the separator to obtain a laminate. The laminates were charged with the electrolytes of Example 1 and Comparative Examples 1 to 4 to obtain lithium secondary batteries of Example 2 and Comparative Examples 5 and 8.

The initial efficiency of each of the lithium secondary batteries according to Example 2 and Comparative Examples 5 to 8 was evaluated according to the conditions shown below.

Test conditions: Aging at room temperature for 1 hour, and formation charging/discharging current density of 0.2 mA·cm⁻²

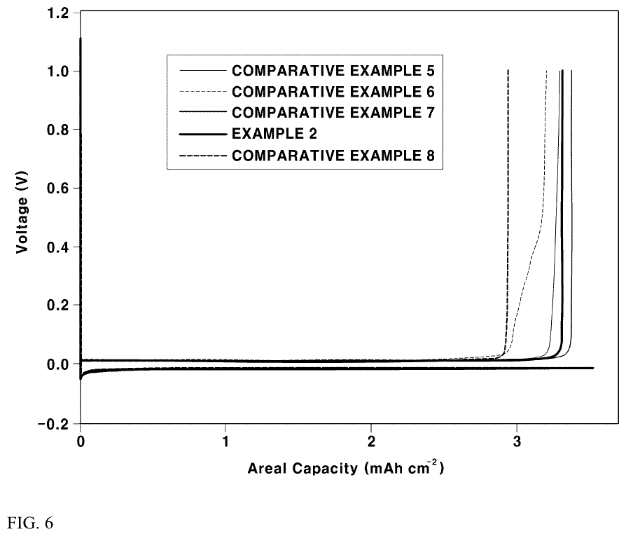

FIG. 6 shows the results of measurement of the initial efficiency of each of the lithium secondary batteries according to Example 2 and Comparative Examples 5 to 8. Referring to FIG. 6, the battery of Comparative Example 8 in which the third additive was not used showed a low initial efficiency of 83.2%. The batteries of Comparative Examples 5 and 6 in which the contents of the third additive were 2.0% by weight and 1.5% by weight, respectively showed initial efficiencies of 93.3% and 90.7%, respectively. The battery of Comparative Example 6 showed that the overvoltage is large. This is because when lithium plated on the copper foil is stripped and transferred to the lithium metal layer, a side reaction occurs at the interface layer of the plated lithium a thick film is formed due to the product of the side reaction. The lithium secondary battery according to Example 2 exhibited an initial efficiency of 93.8%.

The lithium secondary battery according to an exemplary embodiment of the present disclosure is excellent in lifespan performance and lithium ion reversibility under the following conditions: a high current density of 3.0 mAh·cm⁻², a small electrolyte amount of about 3.6 mg·mAh⁻¹ and a lithium metal layer having a high specific capacity of 2.0 mAh·cm⁻², a thin thickness of about 20 μm, and a high lithium utilization rate of 75% or more.

Although examples and experimental examples according to an exemplary embodiment of the present disclosure have been described for illustrative purposes, those skilled in the art will appreciate that various modifications, additions and substitutions are possible, without departing from the scope and spirit of the present disclosure as defined by the appended claims.

The foregoing descriptions of specific exemplary embodiments of the present invention have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the present disclosure and their practical application, to enable others skilled in the art to make and utilize various exemplary embodiments of the present invention, as well as various alternatives and modifications thereof. It is intended that the scope of the present disclosure be defined by the Claims appended hereto and their equivalents.

What is claimed is:

1. An electrolyte for a lithium secondary battery, the electrolyte comprising:
a solution comprising an organic solvent, a co-solvent comprising a fluorine-based compound and being a different kind from the organic solvent, and a lithium salt;
a first additive comprising a fluorine element;
a second additive comprising a nitrogen element; and
a third additive comprising a cyclic carbonate-based compound.

2. The electrolyte according to claim 1, wherein the organic solvent comprises at least one of dimethyl ether, 1,2-dimethoxyethane, 1,2-diethoxyethane, 1,3-dioxolane, diethylene glycol, tetraethylene glycol, diethylene glycol dimethyl ether, triethylene glycol dimethyl ether, tetraethylene glycol dimethyl ether or any combination thereof.

3. The electrolyte according to claim 1, wherein the co-solvent comprises at least one of 1,1,2,2-tetrafluoroethyl-2,2,3-tetrafluoropropyl ether (TTE), 1,1,2,2-tetrafluoroethyl-1H,1H,5H-octafluoropentyl ether (TFOFE), 1,2-(1,1,2,2-Tetrafluroethoxy) ethane (TFE), fluoroethylene carbonate (FEC), bis(2,2,2-trifluoroethyl) ether (BTFE), ethyl 4,4,4-trifluorobutyrate (ETFB), bis(2,2,2-trifluoroethyl) carbonate (TFEC) or any combination thereof.

4. The electrolyte according to claim 1, wherein the electrolyte comprises the organic solvent and the co-solvent in a volume ratio in a range of about 5:5 to 9:1.

5. The electrolyte according to claim 1, wherein the lithium salt comprises at least one of lithium bis(fluorosulfonyl) imide (LiFSI), lithium bis(trifluoromethanesulfonyl) imide (LiTFSI), LiBF₄, LiSbF₆, LiAsF₆, LiN(SO₂CF₃)₂, LiC₄F₉SO₃, LiClO₄, LiAlO₂, LiAlCl₄, LiCl, LiI or any combination thereof.

6. The electrolyte according to claim 1, wherein the solution comprises the lithium salt in a concentration of about 1.5 M to 3M.

7. The electrolyte according to claim 1, wherein the first additive comprises at least one of lithium difluoro (bisoxalato) phosphate (LiDFBP), lithium difluoro (bisoxalato) borate (LiDFOB), difluoroethylene carbonate (DFEC), fluoroethylene carbonate (FEC), lithium difluorophosphate (LiPO₂F₂), lithium difluoro (oxalate) borate (LiFOB), lithium tetrafluoro (oxalato) phosphate (LiTFOP), LiPF₆ or any combination thereof.

8. The electrolyte according to claim 1, wherein the second additive comprises at least one of lithium nitrate (LiNO₃), potassium nitrate (KNO₃), sodium nitrate (NaNO₃), zinc nitrate (Zn(NO₃)₂), magnesium nitrate (Mg(NO₃)₂), lithium nitride (Li₃N), imidazole (C₃H₄N₂) or any combination thereof.

9. The electrolyte according to claim 1, wherein the third additive comprises a cyclic carbonate-based compound represented by Formula 1 below. 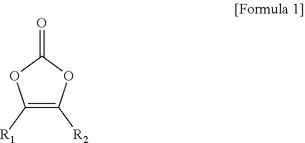
wherein R₁ and R₂ each comprises a hydrogen (H) or an alkyl group having 1 to 3 carbon atoms.

10. The electrolyte according to claim 1, wherein the third additive comprises at least one of vinylene carbonate, 4-methylvinylene carbonate, 4-ethylvinylene carbonate or any combination thereof.

11. The electrolyte according to claim 1, wherein the electrolyte comprises about to 1.5% by weight of the first additive, about 0.1% to 5% by weight of the second additive, about 0.01% to 0.5% by weight of the third additive, and the remaining percentage by weight of the solution.

12. A lithium secondary battery comprising:
a cathode comprising a cathode current collector and a cathode active material layer, a first surface of which is disposed on the cathode current collector;
an anode comprising an anode current collector, a lithium metal layer, a first surface of which is disposed on the anode current collector, and a solid electrolyte interface layer disposed on a second surface of the lithium metal layer;
a separator interposed between the anode and the cathode; and
the electrolyte of claim 1, wherein the electrolyte with which the separator is impregnated.

13. The lithium secondary battery of claim 12,
wherein the cathode further comprises a film formed on a second surface of the cathode active material layer, and
wherein the film is derived from the first additive contained in the electrolyte.

14. The lithium secondary battery of claim 12, wherein the lithium metal layer has a thickness of about 10 μm to 200 μm.

15. The lithium secondary battery of claim 12, wherein the solid electrolyte surface layer comprises:
a first layer, a first surface of which is disposed on the second surface of the lithium metal layer, and comprising lithium fluoride (LiF);
a second layer, a first surface of which is disposed on a second surface of the first layer, and comprising lithium nitride (Li₃N);
a third layer, a first surface of which is disposed on a second surface of the second layer, and comprising a decomposition product of the first additive; and
a fourth layer, a first surface of which is disposed on a second surface of the third layer and a second surface of which is disposed on the separator, and comprising a polymerization product of the third additive.

16. The lithium secondary battery of claim 15, wherein the fourth layer comprises polyvinylene carbonate.

17. The lithium secondary battery of claim 12, wherein the solid electrolyte interface layer has a thickness of about 100 nm to 10 μm.

18. The lithium secondary battery of claim 12, wherein the lithium secondary battery comprises the electrolyte in an amount of about 2 mg·mAh⁻¹ to 5 mg·mAh⁻¹ with respect to a specific capacity of electrodes.
